(19) United States
(12) Patent Application Publication
(10) Pub. No.: US 2009/0139456 A1
(43) Pub. Date: Jun. 4, 2009

(54) SYSTEM AND METHOD FOR MAINTAINING ENVIRONMENTAL OPTIMUM OF AQUARIUM

(76) Inventor: Ping-Liang LIN, Taipei County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/949,181

(22) Filed: Dec. 3, 2007

(51) Int. Cl. A01K 63/00; G05B 13/00

(52) U.S. Cl. 119/245

(57) ABSTRACT

A system for maintaining the environmental optimum inside the water stored in an aquarium is provided. The system includes a maintaining unit, a sensing unit, and a processing/controlling unit. The maintaining unit is used to adjust the ecological environment inside the water. The sensing unit detects the physical and chemical characteristics of the water and outputs an environmental data in responsive to the detected characteristics. The processing/controlling unit receives and analyzes the environmental data for estimating the ecological environment inside the water so as to control the maintaining unit according to the estimation. Therefore, the system is capable of maintaining the environmental optimum of the aquarium meeting the requirement of the aquatic animals and plants therein.

### BACKGROUND OF THE INVENTION

1. Field of the Invention

The present invention is related to a maintaining system, and more particular to a system for maintaining the environmental optimum of an aquarium.

2. Description of Related Art

Setting an aquarium for exhibiting aquatic animals and plants, such as fish and water grass, not only can beautify the environment but also can enrich the daily life.

Most aquatic animals and plants are extremely sensitive to the living environment. The excrement drained by the aquatic animals and the un-eaten feed will pollute the water gradually and accelerate eutrophication that will make the ecological system inside the aquarium unbalanced. The unbalanced aquatic environment will affect the health and growth of the living things and even result in the pathological change or death. Ecological balance inside the aquarium relating to the health and growth of the living things depends on the good water quality. Therefore, besides supplying feed and fertilizer on time, it is also necessary to drain off polluted water and fill fresh water on time for keeping the water quality and feed the water with some required additive, such as antibiotics, probiotics and mineral substance.

The job to maintain the aquarium, including cleaning the environment and feeding the aquatic living things, is usually accomplished artificially. Once the person in charge has to leave over a long period of time, the maintenance of the aquarium becomes a problem. Even though in the daily life, the regular maintenance might be neglected easily because of carelessness. Currently, people can use automatic appliances, such as feeding devices and air pumps, to feed the aquatic animals regularly and keep the concentration of the required gas inside the water. However, water treatment and feeding additive medicament still have to be taken on a regular schedule or according to the water quality by visual judgment. The actual content of gas and substances of the water is unknown so that the real state of major circulations of the water cannot be estimated. Thus, the ecological unbalance usually cannot be handled immediately.

Therefore, the inventor offers the present invention for overcoming the problems due to the artificial maintenance of the aquarium.

### SUMMARY OF THE INVENTION

Accordingly, the scope of the present invention provides a system and method for maintaining the environmental optimum inside the water stored in an aquarium that maintains the ecological optimum of the aquarium meeting the growth requirement of the aquatic animals and plants by automatically detecting the environmental data of the water and adjusting the ecological environment of the water in accordance with the estimation of the detected environmental data.

The present invention provides a system for maintaining the environmental optimum inside the water stored in an aquarium. The system includes a maintaining unit, a sensing unit, and a processing/controlling unit. The maintaining unit is capable of adjusting the ecological environment inside the water stored in the aquarium. The sensing unit detects the physical and chemical characteristics and outputting an environmental data in responsive to the detected physical and chemical characteristics. The processing/controlling unit receives and analyzes the environmental data for estimating the ecological environment of the water so as to control the maintaining unit in accordance with the estimation.

The present invention further provides a method for maintaining the environmental optimum inside the water stored in an aquarium. The method includes the following steps. Firstly, the physical and chemical characteristics of the water are detected for obtaining an environmental data. Next, the ecological environment is estimated in accordance with the environmental data for obtaining an estimation data. Lastly, a maintaining unit is controlled in accordance with the estimation data.

Therefore, the system and method for maintaining the environmental optimum inside the water stored in an aquarium is capable of maintaining the optimum ecological conditions of the aquarium automatically for providing the aquatic animal and plants a stable and superior living environment so as to make the aquatic living things growing healthily.

The objective of the present invention will no doubt become obvious to those of ordinary skill in the art after reading the following detailed description of the preferred embodiment, which is illustrated in the various figures and drawings.

### BRIEF DESCRIPTION OF THE DRAWINGS

The present invention can be fully understood from the following detailed description and preferred embodiment with reference to the accompanying drawings, in which:

FIG. 1 is a block diagram of the system for maintaining the environmental optimum inside the water stored in an aquarium according to the present invention;

FIG. 2 illustrates an embodiment of applying the system for maintaining the environmental optimum inside the water stored in an aquarium according to the present invention;

FIG. 3 is a flow chart of the method for maintaining the environmental optimum inside the water stored in an aquarium according to the present invention; and

FIG. 4 is a flow chart of an embodiment of the method for maintaining the environmental optimum inside the water stored in an aquarium according to the present invention.

### DETAILED DESCRIPTION OF THE PREFERRED EMBODIMENTS

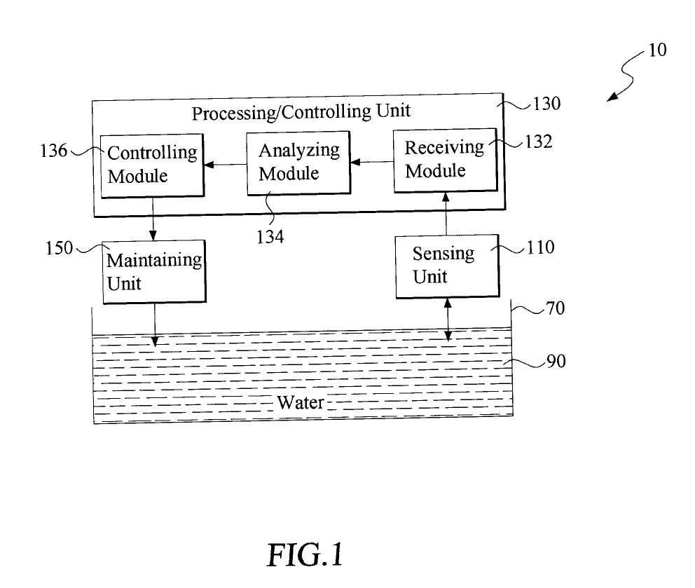

The present invention provides a system and method to control the closed ecological system inside the aquarium balanced for making the ecological conditions of the aquarium meeting the requirement of the aquatic living things therein. Please refer to FIG. 1 which illustrates a block diagram of the system for maintaining the environmental optimum inside the water stored in an aquarium according to the present invention. As shown in FIG. 1, an aquarium 70 stores water 90 for breeding aquatic animals and plants, such as fish, water grass, and waterweed. The maintaining system 10 maintains the ecological environment of water 90 automatically so as to provide an optimum ecological environment for keeping the living things therein growing healthily.

The management of biological loading, nitrogen cycle, and nutrient cycle are essential factors to keep the ecological system of the water balanced and relates to the health and the growth of the living things. In the present invention, we define the physical and chemical characteristics, such as the water level, the oxygen content, the nitrogen content, the chlorine content, the concentration of other harmful substances (such as NH3, NH4, or NH2), and etc., of the water 90 as the ecological references thereof. As the ecological system is balanced, those ecological references will respectively lie in an individual regular range. In another word, one can know whether the ecological system is balanced or not by detecting whether the ecological references are regular or not. The maintaining system 10 according to the present invention monitors the ecological references of the water 90 and as one or more detected ecological reference is irregular, adjusts the ecological environment immediately in order to keep the ecological system balanced. The ecological references vary with the species and amount of the aquatic living things. We could scheme out the ecological optimum and set the ecological references individually with corresponding regular range in the maintaining system 10 in accordance with the species and amount of the living animals inside the aquarium 70.

The maintaining system 10 includes a sensing unit 10, a processing/controlling unit 130, and a maintaining unit 150. The maintaining unit 150 implies the feeding device, the air pump, the water treatment device, the heater, or etc. disposed inside or close to the aquarium 70 for adjusting the ecological environment of the water 90. The sensing unit 110 includes the water-level sensor, ion sensor, temperature sensor, and etc. disposed in the water 90 for detecting the physical and chemical characteristics thereof and generates an environmental data in responsive to the detected physical and chemical characteristics. The processing/controlling unit 130 is coupled to the sensing unit 110 and the maintaining unit 150 for receiving and analyzing the environmental data for estimating the ecological environment of the water 90 so as to control the maintaining unit 150 according to the estimation in order to keep each ecological references being in individual regular range which enable the aquatic animals and plants to grow healthily.

The processing/controlling unit 130 includes a receiving module 132, an analyzing module 134, and a controlling module 136. The receiving module 132 is coupled to the sensing unit 110 for receiving the environmental data sent therefrom. The analyzing module 134 is coupled to the receiving module 132 for analyzing the received environmental data for obtaining a plurality of ecological references reflecting to the environment of the water 90, and compares each reference with a corresponding regular range in order to verify if the ecological reference is regular and estimate whether it is necessary to adjust the ecological environment. The analyzing module 134 further generates an estimation data sent out according to the estimation. The controlling module 136 is coupled to the analyzing module 134 for receiving the estimation data and controls the maintaining module 150 in responsive to the received estimation data.

That is to say, if according to the estimation data, there is one or more ecological reference of the water 90 is irregular, the controlling module 136 will output signal to control the maintaining unit 150 to adjust the ecological environment inside the water 90 for tuning the irregular reference to the regular range. For example, if according to the estimation data generated from the analyzing module 134 shows that the concentration of harmful substances (such as NH3, NH4, or NH2) inside the water 90 exceeds the regular range, the controlling module 136 will generate signal to drive the maintaining module 150 drain off polluted water and fill fresh water so as to drop the concentration of harmful substances to the regular range.

In one embodiment, the processing/controlling unit 130 can be implemented by use of a programmable logic controller. A programmable logic controller is equivalent to a simplified computer which has basic components, such as processor, memory, and the etc. disposed therein and is installed an operating system. Thus, the processing/controlling unit 130 is able to receive and transmit signals for monitoring and controlling the peripheral according to the program written inside the memory. In the present invention, we can store the basic control program inside the memory of the programmable logic controller so as to build the basic function of the receiving module 132, the analyzing module 134, and the controlling module 136. The user can set the ecological references into the controller according to the practical ecological environment of the water 90 to enable the maintaining system 10 to work as the function set above.

In one embodiment, the processing/controlling unit 130 further can control the maintaining unit 150 under a preset time schedule according to a pre-stored controlling procedure. For example, if the aquatic animals should be fed on time daily, one can build the relative controlling procedure inside the processing/controlling unit 130 so as to make the controlling module 136 to control the maintaining unit 150 putting a specific feed with pre-determined amount into the water 90. Furthermore, if it is necessary to fill fresh water with a specific proportion, one can build the relative controlling procedure inside the processing/controlling unit 130 so as to make the controlling module 136 to control the maintaining unit 150 draining off the polluted water and filling fresh water into the aquarium. It is noted that the function set above can be implemented by well-known programmable logic controller technology. Therefore, the relative technology will not be mentioned in detail herein.

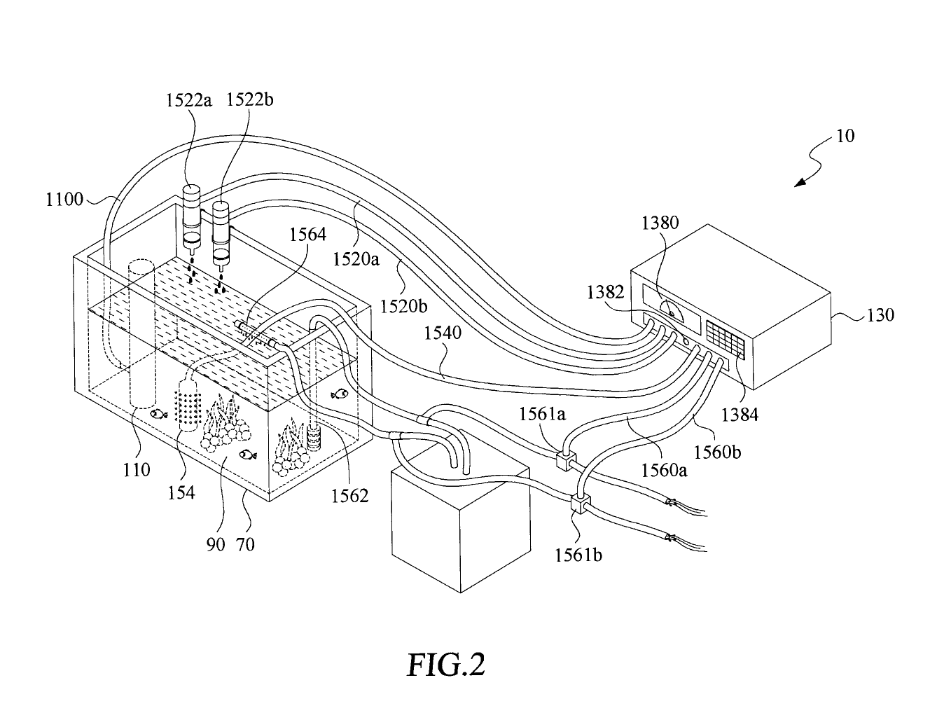

Please refer to FIG. 2 which illustrates an embodiment of applying the maintaining system according to the present invention. As shown in FIG. 2, the processing/controlling unit 130 is a stand-alone apparatus including a displaying panel 1380, a signal interface 1382, and an inputting interface 1384. The receiving module 132, the analyzing module 134, and the controlling module 136 shown in FIG. 1 are disposed inside the apparatus. The displaying panel 1380 is used to display information for assisting the users to operate the apparatus. The signal interface 1382 is coupled between the receiving module 132 and the controlling module 136 for transmitting signals between the apparatus and the peripheral.

The sensing unit 110 is disposed inside the aquarium 70 and is electrically coupled to the receiving module 1382 through the transmission line 1100. The sensing unit 110 detects the physical and chemical characteristics of the water 90 and generates an environmental data in responsive to the detected characteristics which environmental data will be further transmitted to the receiving module 132. In the embodiment shown in FIG. 2, the maintaining unit 150 includes a feeding device 152, an air pump 154, and a water treatment device 156.

The feeding device 152 has a plurality of feeding containers 1522a, 1522b for respective installing different additive, such as feeding, antibiotics, mineral substances, probiotics, and etc., prepared to be fed into the water 90. The controlling module 136 is electrically coupled to the feeding containers 1522a, 1522b by transmission lines 1520a, 1520b for respectively controlling the open timing and the open time period of each feeding container 1522a, 1522b so as to control the amount of the fed additive.

The air pump 154 is electrically coupled to the controlling module 136 through the transmission line 1540 and the volume of the air generated from the air pump 154 is under the control of the controlling module 136.

The water treatment device 156 is used to fill and drain off the water of the aquarium 70 for diluting the concentration of the particles with the fresh water. As shown in FIG. 2, the water treatment device 156 consists of two valves 1561a, 1561b and two water pipes 1562, 1564 which is respectively connected to an external water outlet and a water inlet. The valves 1561a, 1561b are coupled to the signal interface 1382 of the control module 136 by transmission lines 1560a, 1560b. The control module 136 controls the valves 1561a, 1561b to control the flow of the water pipes 1562, 1564 so as to drain off the polluted water and fill fresh water.

In one embodiment, the maintaining system 10 is used to maintain the nitrogen cycle of the aquarium 70. The nitrate and nitrite converted from the ammonia and ammonium in the excrement drained from the aquatic animals are the major factors to make the fish suffering pathological change or death, decelerate the growth of the fish, and accelerate the growth of the algae. The nitrobacteria is able to convert the ammonia and ammonium to the nitrate and nitrite by nitrification, and the anaerobic bacteria is able to convert the nitrate to the nitrogen that will be drained away afterwards. The maintaining system 10 is able to detect the concentration of the ammonia and nitrogen, and as the detected concentration exceeds the corresponding regular range, drive the maintaining unit 150 to feed the water 90 with the nitrobacteria and anaerobic bacteria sequentially immediately for keeping good nitrogen cycle.

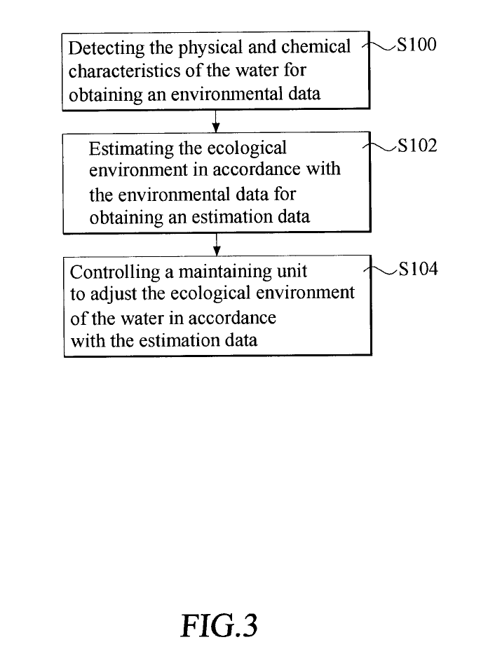

Please refer to FIG. 3 which illustrates a flow chart of the method for maintaining the environmental optimum inside the water stored in an aquarium according to the present invention. Please also refer to FIG. 1 and FIG. 2 for the elements mentioned hereinafter. As shown in FIG. 3, the method includes the following steps.

First, S100 is performed. The physical and chemical characteristics of the water are detected for obtaining an environmental data

Next, S102 is performed. The ecological environment of the water 90 is estimated in accordance with the environmental data.

Lastly, S104 is performed. The maintaining unit 150 is controlled to adjust the ecological environment of the water 90 in accordance with the estimation data.

In one embodiment, the estimation of the ecological environment inside the water 90 further includes the following steps.

First, the environmental data is analyzed for obtaining at least one ecological reference.

Next, the ecological reference is compared with a corresponding regular range.

Lastly, the estimation is generated in accordance with the comparison in the previous step.

One must build a basic balanced system inside a newly set up aquarium before disposing the aquatic living things therein. Currently, the basic balanced system is built up artificially and usually takes several days to several weeks. Even so, the water quality depends on the experience of the people in charge and hardly meets the requirement of the aquatic living things.

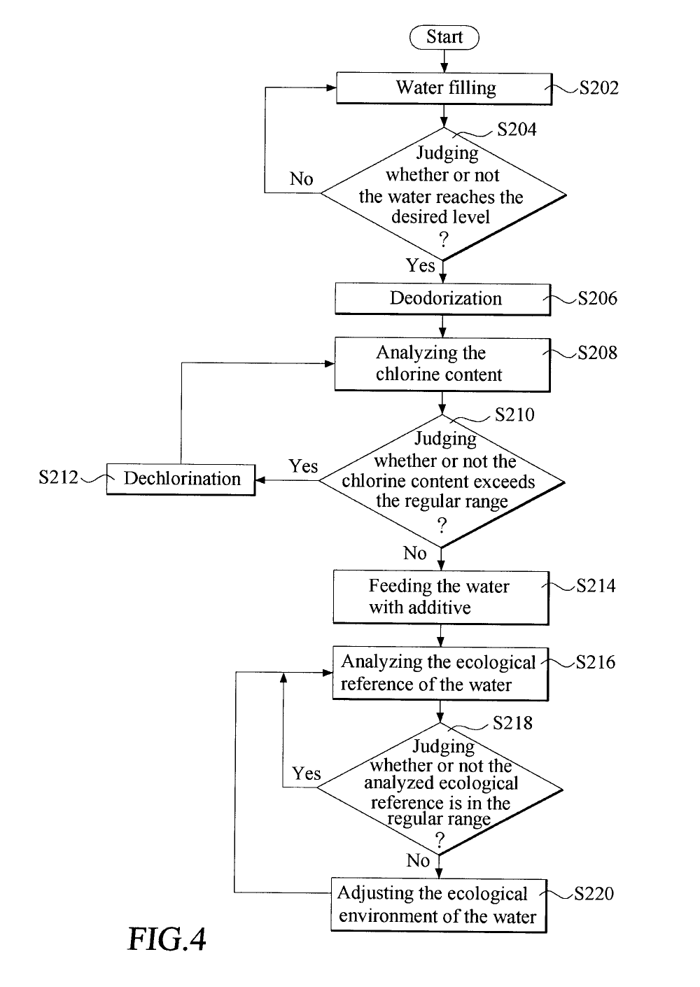

The maintaining system 10 is capable of developing a balanced system with good water quality automatically. Please refer to FIG. 4 which illustrates a flow chart of an embodiment of the method for maintaining the environmental optimum inside the water stored in an aquarium according to the present invention. Please also refer to FIG. 1 and FIG. 2 for the elements mentioned hereinafter.

After setting the relative controlling procedure and all the ecological references with individual regular range, the user could switch on the maintaining system 10. As shown in FIG. 4, S202 is performed firstly. The processing/controlling unit 130 controls the water treatment device 156 to fill fresh water in the aquarium 70. Next, S204 is performed. The processing/controlling unit 130 judges whether the water has been reached the desired level. If the judgment of S204 is no, S202 is performed continually. If the judgment of S204 is yes, the next step S206 is performed for deodorization. The user can feed the water 90 with active carbon or alum artificially. Next, S208 is performed. The chlorine content of the water 90 is analyzed in accordance with the environmental data sent from the sensing unit 110. Next, S210 is performed. The processing/controlling unit 130 judges whether the chlorine content exceeds a corresponding regular range. If the judgment of S210 is yes, the step S212 is performed for dechlorination. The processing/controlling unit 130 controls the maintaining unit 150 feeds the water 90 with antichlor and S208 is performed again. If the judgment of S210 is no, the next step S214 is performed. The processing/controlling unit 130 controls the maintaining unit 150 to feed the water 90 with desired additive according to the pre-stored setting. Next, S216 is performed. The ecological references of the water 90 are analyzed. Next, S218 is performed. The processing/controlling unit 130 judges whether the analyzed ecological references are regular. If the judgment of S218 is yes, S216 is performed again. If the judgment of S218 is no, the next step S220 is preformed. The processing/controlling unit 130 controls the maintaining unit 150 to adjust the ecological environment of the water 90 so as to make the ecological references meets their individual regular range.

After the basic ecological system has been built up, the user can dispose the aquatic animals and plants in the aquarium 70 and maintain the balanced nitrogen cycle and nutrient cycle by use of the maintaining system 10.

Therefore, through the embodiment illustrated above, one should realize that the system and method for maintaining the environmental optimum inside the water stored in an aquarium is capable of maintaining the optimum ecological conditions of the aquarium for making the aquatic living things growing healthily by automatically detecting the environmental data of the water and adjusting the ecological environment of the water in accordance with the estimation of the detected environmental data. In comparison with artificial maintenance, the system and method of the present invention maintains the aquarium on time and immediately so as to provide the aquatic animal and plants a stable and superior living environment.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A system for maintaining the environmental optimum inside the water stored in an aquarium, comprising:
a maintaining unit, capable of adjusting the ecological environment inside the water stored in the aquarium;
a sensing unit, detecting a plurality of physical and chemical characteristics and outputting an environmental data in responsive to the detected physical and chemical characteristics; and
a processing/controlling unit, receiving and analyzing the environmental data for estimating the ecological environment of the water so as to control the maintaining unit in accordance with the estimation.

2. The system according to claim 1, wherein the processing/controlling unit further controls the maintaining unit in accordance with a preset time schedule.

3. The system according to claim 2, wherein the processing/controlling unit comprises:
a receiving module, coupled to the sensing unit for receiving the environmental data;
an analyzing module, coupled to the receiving module for analyzing the received environmental data to obtain at least one ecological reference, and comparing the ecological reference with a corresponding regular range in order to estimate the ecological environment inside the water, and further output an estimation data; and
a controlling module, coupled to the analyzing module and the maintaining unit for receiving the estimation data and controlling the maintaining unit in accordance with the estimation data.

4. The system according to claim 3, wherein the ecological reference is one selected from the group consisting of the water level, the oxygen content, the nitrogen content, the chlorine content, and the concentration of other substances.

5. The system according to claim 1, wherein the maintaining unit comprises a feeding device coupled to the processing/controlling unit which the feeding device contains a plurality kinds of additive and the feeding device feeds the water with the additive under the control of the processing/controlling unit.

6. The system according to claim 5, wherein the feeding device comprises a plurality of feeding containers for installing one kind of the additive individually.

7. The system according to claim 6, wherein the additive is one selected from the group consisting of feeding, fertilizer, antibiotics, mineral substance, probiotics, antichlor, nitrobacteria, and anaerobic bacteria.

8. The system according to claim 1, wherein the maintaining unit comprises a water treatment device coupled to the processing/controlling unit which the water treatment device fills and drains the water under the control of the processing/controlling unit.

9. The system according to claim 1, wherein the maintaining unit comprises an air pump coupled to the processing/controlling unit which the air pump provides the desired gas to the water under the control of the processing/controlling unit.

10. The system according to claim 1, wherein the processing/controlling unit is implemented by use of a programmable logic controller.

11. A method for maintaining the environmental optimum inside the water stored in an aquarium, comprising the steps of:
detecting a plurality of physical and chemical characteristics of the water for obtaining an environmental data;
estimating the ecological environment in accordance with the environmental data for obtaining an estimation data; and
controlling a maintaining unit to adjust the ecological environment of the water in accordance with the estimation data.

12. The method according to claim 11, wherein in the step of obtaining the estimation data comprises the steps of:
analyzing the environmental data for obtaining at least one ecological reference;
comparing the ecological reference with a corresponding regular range; and
generating the evaluation data in accordance with the comparison in the previous step.

13. The method according to claim 12, further comprising the steps of:
building a controlling procedure which comprises a preset time schedule, the ecological reference with corresponding regular range.

14. The method according to claim 13, further comprising the steps of:
controlling the maintaining unit under the preset time schedule in accordance with the controlling procedure.

15. The method according to claim 12, wherein the ecological reference is one selected from the group consisting of the water level, the oxygen content, the nitrogen content, the chlorine content, and the concentration of other substances.

16. The method according to claim 11, wherein the maintaining unit comprises a feeding device coupled to the processing/controlling unit which the feeding device contains a plurality kinds of additive and the feeding device feeds the water with the additive under the control of the processing/controlling unit.

17. The method according to claim 16, wherein the feeding device comprises a plurality of feeding containers for installing one kind of the additive individually.

18. The method according to claim 17, wherein the additive is one selected from the group consisting of feeding, fertilizer, antibiotics, mineral substance, probiotics, antichlor, nitrobacteria, and anaerobic bacteria.

19. The method according to claim 11, wherein the maintaining unit comprises a water treatment device coupled to the processing/controlling unit which the water treatment device fills and drains the water under the control of the processing/controlling unit.

20. The method according to claim 11, wherein the maintaining unit comprises an air pump coupled to the processing/controlling unit which the air pump provides the desired gas to the water under the control of the processing/controlling unit.
